(19) United States
(12) Patent Application Publication
(10) Pub. No.: US 2012/0084757 A1
(43) Pub. Date: Apr. 5, 2012

(54) COMPUTER-READABLE, NON-TRANSITORY MEDIUM SAVING DEBUGGING SUPPORT PROGRAM, DEBUGGING SUPPORT DEVICE, AND DEBUGGING SUPPORT METHOD

(75) Inventor: Yutaka TAMIYA, Kawasaki (JP)

(73) Assignee: FUJITSU LIMITED, Kawasaki-shi (JP)

(21) Appl. No.: 13/165,173

(22) Filed: Jun. 21, 2011

(30) Foreign Application Priority Data
Oct. 1, 2010 (JP) 2010-224366

(51) Int. Cl. G06F 9/44

(52) U.S. Cl. 717/124

(57) ABSTRACT

A computer-readable, non-transitory medium saving a debugging support program representing a sequence of instructions, the program which is executable by a target computer to perform receiving a connection request for remotely debugging a process, of which an identifier is designated for the remote debugging, using a host computer; searching a plurality of processes activated in the target computer for the process having the designated identifier; and connecting the target computer to the host computer to enable remotely debugging the searched process having the designated identifier.

### CROSS-REFERENCE TO RELATED APPLICATIONS

This patent application is based upon and claims the benefit of priority of the prior Japanese Patent Application No. 2010-224366 filed on Oct. 1, 2010, the entire contents of which are incorporated herein by reference.

### FIELD

A certain aspect of the embodiments discussed herein is related to a debugging support program, a debugging support device, and a debugging support method.

### BACKGROUND

Japanese Laid-open Patent Publication 09-259002 discloses that a debugger command is individually started by plural users. A task group being an object of debugging and a break point are designated and information on the task stopped by the break point is provided. A debugger task stores the debugger command and information for specifying the task group being the object of debugging in a table at every break point and sets the break point in the task. When the task stops at the break point, OS suppresses the execution of all the tasks becoming the objects of debugging with the stopped task. A break report task gives the notice of stopping to the debugger command designating the break point of the stopped task. The OS resumes the execution of the stopped task when the task becoming the object of debugging with the stopped task does not exist.

According to an aspect of the embodiment, a computer-readable, non-transitory medium saving a debugging support program representing a sequence of instructions, the program which is executable by a target computer to perform receiving a connection request for remotely debugging a process, of which an identifier is designated for the remote debugging, using a host computer; searching a plurality of processes activated in the target computer for the process having the designated identifier; and connecting the target computer to the host computer to enable remotely debugging the searched process having the designated identifier.

The object and advantages of the invention will be realized and attained by means of the elements and combinations particularly pointed out in the appended claims.

It is to be understood that both the foregoing general description and the following detailed description are exemplary and explanatory and are not restrictive of the invention as claimed.

### BRIEF DESCRIPTION OF THE DRAWINGS

FIG. 1 illustrates a mechanism of remote debugging;

FIG. 2 illustrates an example configuration for remotely debugging plural processes in parallel;

FIG. 3 illustrates problems which may be caused in remotely debugging the plural processes;

FIG. 4 illustrates an example configuration of a remote debugging system of an embodiment of the present invention;

FIG. 5 illustrates an example functional configuration of a debug client and a debug server of the Embodiment;

FIG. 6 illustrates an example hardware structure of a target machine of the Embodiment;

FIG. 7 illustrates an example process carried out by a debugging support system;

FIG. 8 illustrates example matching information between the debug client and the process to be debugged;

FIG. 9 illustrates a first example of a program ID;

FIG. 10 illustrates a second example of the program ID; and

FIG. 11 illustrates a third example of the program ID.

### DESCRIPTION OF EMBODIMENT

In debugging a program installed in devices such as a portable phone, a way of debugging called “remote debugging” may be used.

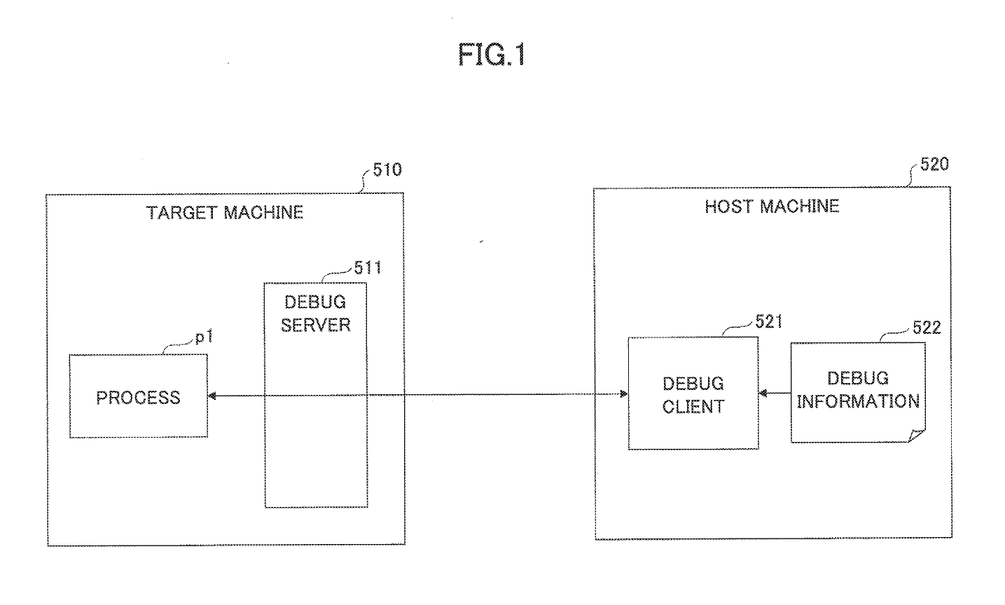

FIG. 1 illustrates a mechanism of remote debugging. Referring to FIG. 1, a process to be debugged is performed in a target machine 510. A user such as a developer uses a host machine 520 in order to debug programs and processes. The target machine 510 and the host machine 520 are connected by a communication line such as a network and a serial cable.

The host machine 520 includes a debug client 521 and debug information 522. The debug client 521 is a program for receiving a debugging instruction from a user and displaying information corresponding to the debugging instruction. The debug client 521 is activated in the host machine 520 in association with a process to be debugged. The debug information 522 includes matching information between a source code of a program for the process to be debugged and address information of various symbols inside the source code such as a variable and a function.

The target machine 510 includes a debug server 511 or the like. The debug server 511 carries out various debugging processes. Referring to FIG. 1, an activated process p1 is subjected to debugging.

For example, if an instruction of referring to register usage or memory usage for the process p1 is input by a user, the debug client 521 transmits a debug command corresponding to the instruction of referring to the register usage or the memory usage for the process p1 to the debug server 511. The debug server 511 acquires the register or memory usage for the process p1 and returns the acquired information to the debug client 521. The debug client 521 causes the received information to be displayed. At this time, the debug client 521 causes the received information to be displayed in a form easily understood by the user using the debug information 522.

With the above remote debugging, processes of devices are easily debugged using an input device, a display device or the like included in a personal computer (PC) or the like.

On the other hand, a multiprocessor system may be used by the devices performing processes due to appearance of operating systems (OS) such as Unix (“Unix” is a registered trademark) and Symbian OS. The devices performing processes may also employ a multi OS system in which plural OSs are simultaneously activated by a virtual technique. Plural processes may be processed in parallel by one device. Therefore, with association of the plural processes, a program realizing a predetermined function can be installed.

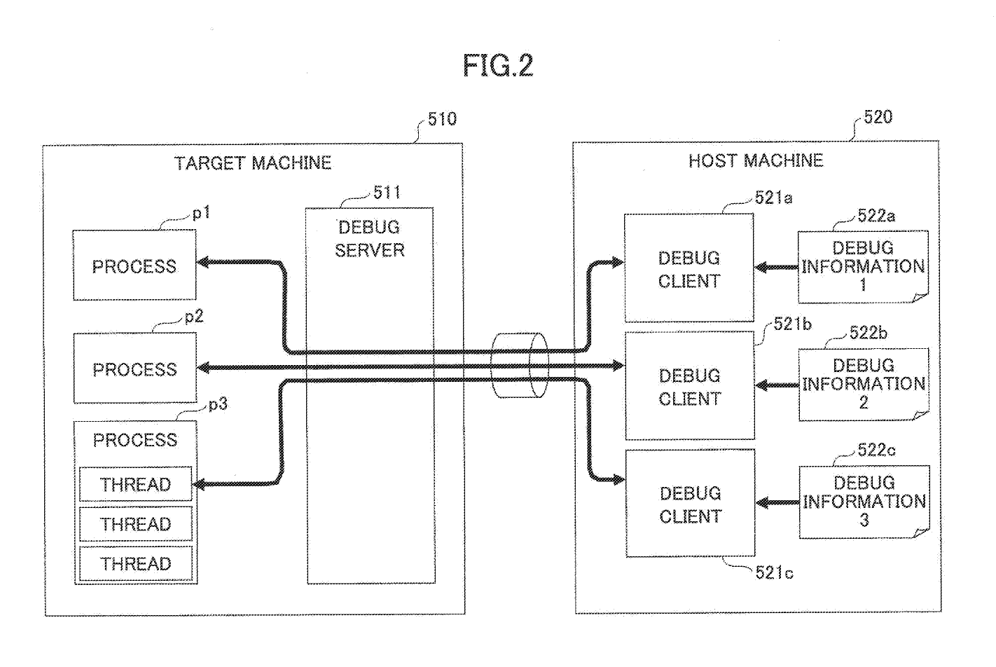

In consideration of the above, efficiency in debugging the processes can be improved by the structure illustrated in FIG. 2.

FIG. 2 illustrates an example configuration for remotely debugging plural processes in parallel. Referring to FIG. 2, the same reference symbols as those in FIG. 1 are given to the same portions as those in FIG. 1, and explanation of these portions is omitted.

Referring to FIG. 2, three processes p1 to p3 are activated in the target machine 510. In the host machine 520, three debug clients 521, debug clients 521a to 521c, are activated. The debug client 521a debugs the process p1. The debug client 521b debugs the process p2. The debug client 521c debugs the process p3. The processes p1 to p3 are related to mutually different programs. Therefore, the debug clients 521a to 521c are activated respectively in relation to mutually different debug information items 522a to 522c.

Referring to FIG. 2, the user can debug the processes p1 to p3 in parallel by operating the debug clients 521a to 521c. However, in order to realize the configuration illustrated in FIG. 2, the debug information 1 522a, the debug information 2 522b, and the debug information 3 522c are correctly allocated to the processes p1 to p3, respectively, and the debug clients 521a, 521b and 521c are activated.

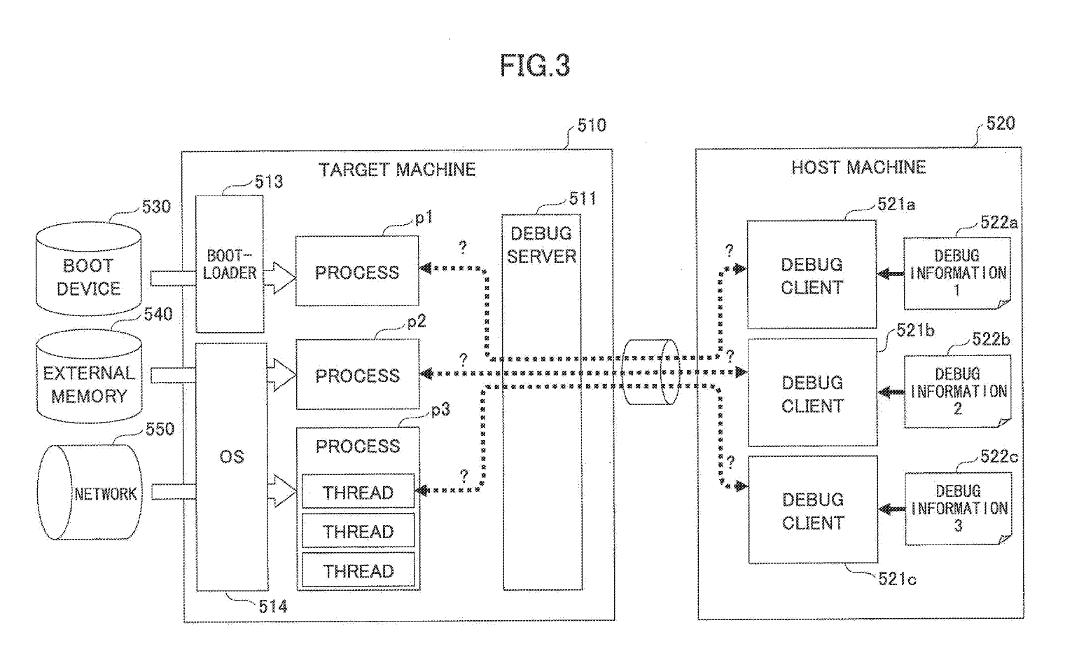

However, in the devices performing the processes, the processes are loaded in the target machine 510 from various sources of loading the processes illustrated in FIG. 3.

FIG. 3 illustrates problems caused in remotely debugging the plural processes. Referring to FIG. 3, the same reference symbols as those in FIG. 2 are given to the same portions as those in FIG. 2, and explanation of these portions is omitted.

Referring to FIG. 3, the process p1 is generated by loading a program recorded in a boot device 530 by a boot loader 513. A process p2 is generated by loading a program recorded in an external memory 540 by an OS 514. A process p3 is generated by loading a program, which is downloaded via a network 550, with the OS 514.

The loading sources of the device may be various.

A timing and method for loading various processes greatly depend on a bootloader and an OS to be installed in the target machine 510. Therefore, the debug server 511 does not always participate in activation of the processes. As a result, the debug server 511 does not easily know the processes loaded by the target machine, times when the processes are loaded, places (e.g. memory addresses) where the processes are loaded, and process IDs of the processes.

Accordingly, as indicated by marks “?” in FIG. 3, it is difficult for the debug server 511 to know correspondences between various processes p1, p2 and p3 in the target machine 510 and the debug information 522 (e.g., the debug information 1 522a, the debug information 2 522b and the debug information 3 522c,) or the debug clients 521 (e.g., the debug clients 521a, 521b and 521c) in the host machine 520.

Preferred embodiments of the present invention will be explained with reference to accompanying drawings.

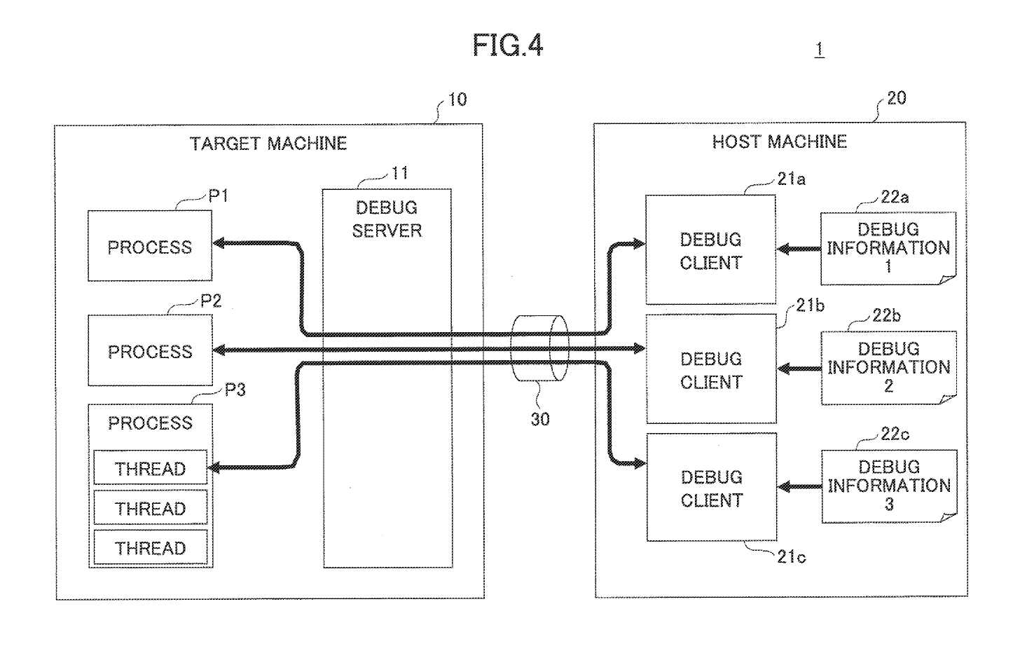

Hereinafter, the Embodiment is described with reference to FIG. 4 through FIG. 11. FIG. 4 illustrates an example configuration of a remote debugging support system 1 of the Embodiment of the present invention. Referring to FIG. 4, the remote debugging support system 1 includes the target machine 10 and the host machine 20. The target machine 10 and the host machine 20 are connected by a wired or wireless communication line 30 such as a network or a serial cable. Plural host machines 20 may be connected to one target machine 10.

The process to be debugged is activated by the target machine 10. An example mode of performing usefulness of the remote debugging is a device in which a system is installed such as a portable phone, a personal digital assistant (PDA), a smart phone, a digital television and a digital camera. However, as long as the target machine can perform multiple processes and has a communication function, the target machine is not limited to a specific device. In the Embodiment, the target machine 10 is an example of the debugging support device.

The host machine 20 is a computer such as a personal computer (PC) used by a user such as a developer to debug the process of the target machine.

The host machine 20 includes the debug clients 21 and the debug information items 22. The debug clients 21 are programs for receiving debugging instructions from the user and displaying information corresponding to the debugging instructions. One of the debug clients 21 is activated in the host machine 20 in association with a process to be debugged. The debug information items 22 include matching information between a source code of a program for the process to be debugged and address information of various symbols inside the source code such as a variable and a function.

The target machine 10 includes the debug server 11. The debug server 11 debugs processes to be debugged. Referring to FIG. 4, three processes p1 to p3 are activated as objects to be debugged. These processes may be activated in an identical operating system (OS) or different operating systems. For example, in a case where the various processes are activated in the different OSs, plural virtual machines are activated in the target machine 10. In this case, the OSs may be respectively activated for the virtual machines and processes are activated for each of the OSs. Even in a case where the plural virtual machines are activated in the target machine 10, the number of the activated debug servers 11 may be one. In this case, the debug server 11 may be installed as a part of a program called “hypervisor” which manages a virtual machine.

Three debug clients 21a, 21b and 21c are activated in the host machine 20 in association with the three processes. Specifically, the debug client 21a corresponds to the process P1. The debug client 21b corresponds to the process P2. The debug client 21c corresponds to the process P3. Said differently, the debug information 1 22a is one of debug information items 22 of a program related to the process P1, the debug information 2 22b is one of debug information items 22 of the program related to the process P2, and the debug information 3 22c is one of debug information items 22 of the program related to the process P3. The processes P1 to P3 correspond to mutually different programs.

For example, when the instruction of referring to the register usage or the memory usage for the process P1 is input by the user into the debug client 21a, the debug client 21a transmits the debug command corresponding to the instruction of referring to the register usage or the memory usage for the process P1 to the debug server 11. The debug server 11 acquires the register or memory usage for the process P1 and returns the acquired information to the debug client 21a. The debug client 21a causes the received information to be displayed. At this time, the debug client 21a causes the received information to be displayed in a form easily understood by the user using the debug information 22a.

A similar processing flow is carried out when the debug instruction is input into the debug client 21b and the debug client 21c. However, the process P2 is an object to be processed for the debug client 21b, and the process P3 is an object to be processed for the debug client 21c.

As such, the user can carry out remote debugging by operating the host machine 20 for the processes activated in the target machine 10.

The debugging function provided from the debug clients 21 and the debug server 11 is not limited to reference to the register and memory usage. The debug clients 21 and the debug server 11 can provide functions ordinarily provided by debuggers such as a setup and release of a breakpoint and overwriting of the register.

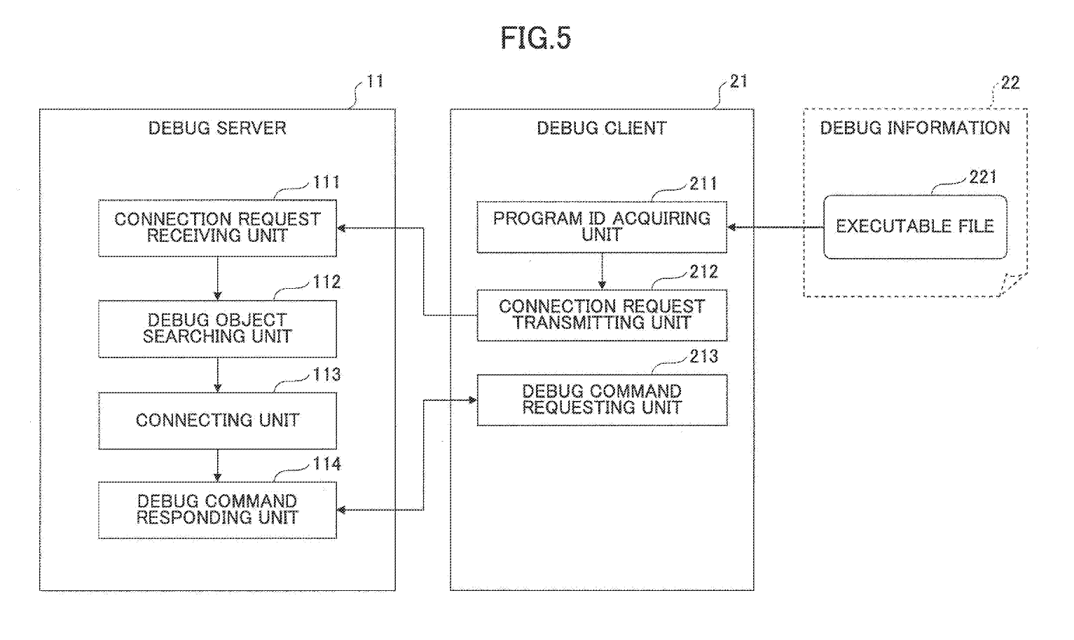

FIG. 5 illustrates an example functional configuration of a debug client and a debug server of the Embodiment. As illustrated in FIG. 5, the debug client 21 includes a program ID acquiring unit 211, a connection request transmitting unit 212 and a debug command requesting unit 213. The program ID acquiring unit 211 acquires an identifier of a program to be debugged, which is included as a part of the debug information 22, from an executable file 221 of a copy of the executable file 221 of the program. In the Embodiment, the identifier is called “program ID”. In the Embodiment, the executable file 221 of the program to be debugged is arranged (stored) on a side of the host machine 20.

The connection request transmitting unit 212 transmits a connection request for remote debugging to the debug server 11. A program ID of the program to be debugged is designated in the connection request.

The debug command requesting unit 213 transmits a debug command responding to the input instruction by the user to the debug server 11 after the connection for the remote debugging is established. The debug command requesting unit 213 causes the information included in the response to the transmitted debug command to be displayed on a display included in the host machine 20.

On the other hand, the debug server 11 includes a connection request receiving unit 111, a debug object searching unit 112, a connecting unit 113 and a debug command responding unit 114.

The connection request receiving unit 111 receives a connection request for the remote debugging from the debug client 21. For example, the connection request receiving unit 111 opens a port for receiving the connection request and waits for a receipt of the connection request at the port.

The debug object searching unit 112 searches plural processes activated in the target machine 10 for a process, from which a value matching the program ID is acquired. In searching the process, the matching value may be stored in a section of a memory space to which “writing” is not performed. In the above, the program ID is designated in the connection request received by the connection request receiving unit 111. The section of the memory space to which “writing” is not performed may be “Read Only”.

The connecting unit 113 constructs a connection relationship or a corresponding relationship between the process searched for by the debug object searching unit 112 and the debug client 21 related to the connection request. For example, the connecting unit 113 opens a new port for communication with the debug client 21 related to the connection request. The connection unit 113 may store the matching information between the port number of the opened port and the process ID of the searched process in the memory device 103. The process ID is allocated to the process by the operating system (OS) when the process is activated.

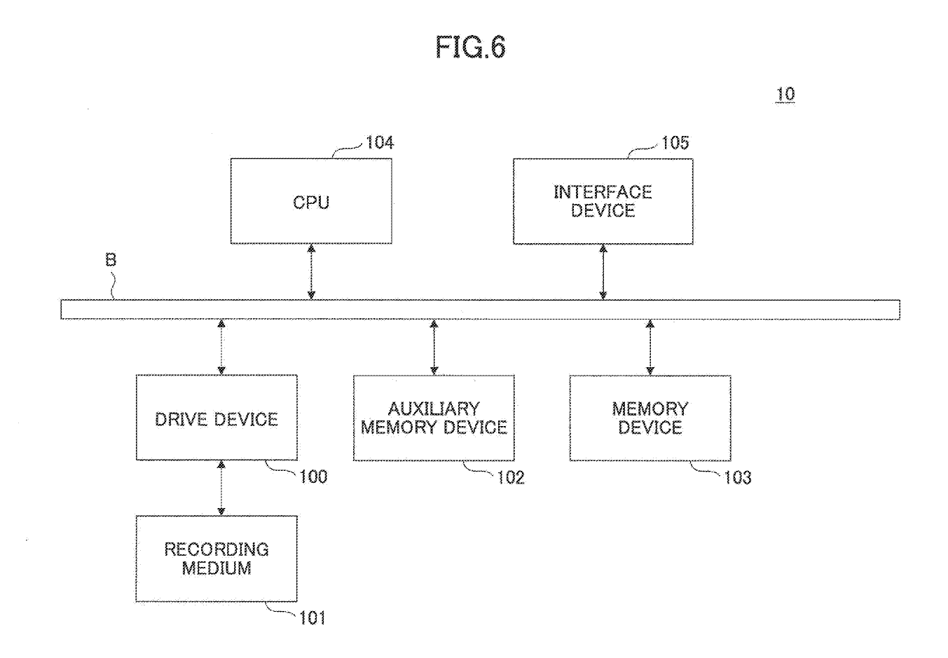

The debug command responding unit 114 waits for a receipt of the debug command from the debug client 21 and carries out the process corresponding to the received debug command. The process carried out by the debug command responding unit 114 is determined based on the port number of the port by which the debug command is received. Matching information between the port number and the process ID is stored in a memory device 103 (FIG. 6). The process whose process ID is stored in the memory device 103 is to be debugged.

FIG. 6 illustrates an example hardware structure of the target machine 10 of the Embodiment. The target machine 10 includes a drive device 100, an auxiliary memory device 102, the memory device 103, a CPU 104 and an interface device 105 which are mutually connected by a bus B.

The program carrying out the process in the target machine 10 is provided by a recording medium 101. When the recording medium 101 with the program recorded on it is installed in the drive device 100, the program is installed in the auxiliary memory device 102 via the drive device 100 from the recording medium 101. However, the program may not always be installed from the recording medium 101 and may be downloaded from another computer via the network. The auxiliary memory device 102 stores predetermined files, data and so on in addition to the installed program.

The memory device 103 reads out the program from the auxiliary memory device 102 when the program is instructed to be activated, and stores the read-out program in the memory device 103. The CPU 104 realizes a function related to the target machine 10 in conformity with the program stored in the memory device 103. The interface device 105 is used as an interface for connecting to the network.

As an example of the recording medium 101, a detachable recording medium such as a CD-ROM, a DVD disk, an SD memory card or a USB memory is exemplified. Further, the example of the auxiliary memory device 102 is a hard disk drive (HDD), a flash memory or the like. Any of the recording medium 101 and the auxiliary memory device 102 may be a recording medium readable by a computer.

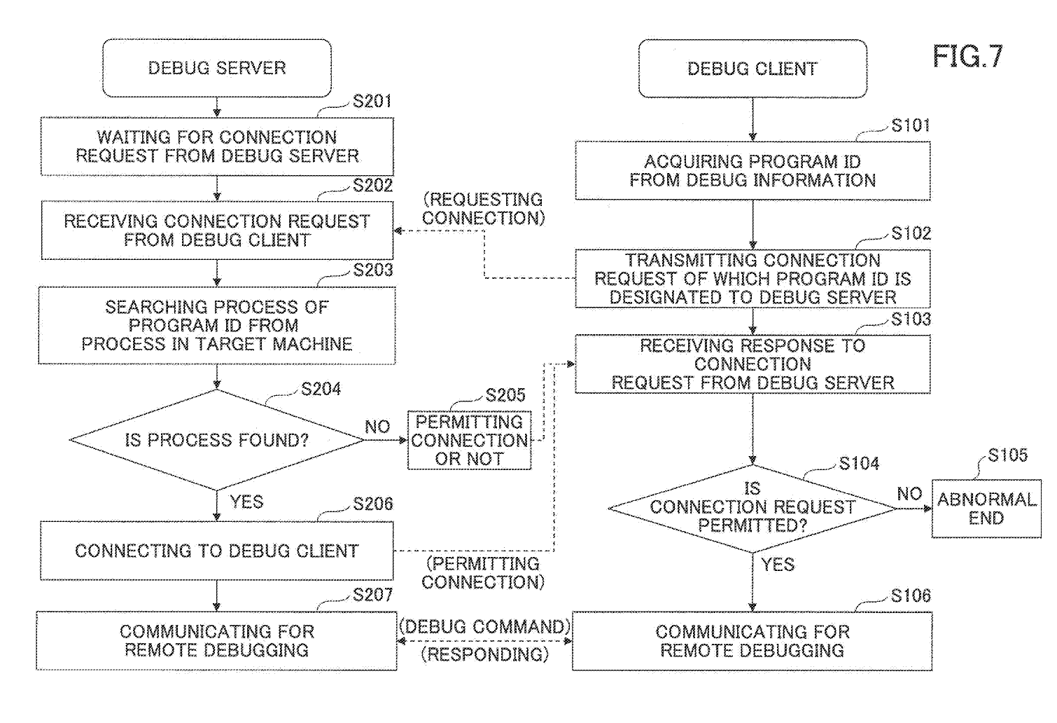

Hereinafter, a procedure of processing in the remote debugging support system 1 is described. FIG. 7 illustrates an example process carried out by a debugging support system. For example, when the user inputs an instruction activating the debug client 21 by designating or selecting any of the debug information 1 22a, the debug information 2 22b and the debug information 3 22c, the process illustrated in FIG. 7 is started to be carried out for the debug client 21. Designation of the debug information 22 substantially corresponds to the program (process) to be debugged.

In step S101, the program ID acquiring unit 211 of the debug client 21 acquires the program ID from the executable file 221 of a program included in the designated debug information 22. Then, the connection request transmitting unit 212 designates the program ID acquired by the program ID acquiring unit 211 and transmits the connection request for the remote debugging to the debug server 11 in step S102. The address information of the transmission destination may be designated at a time of activating the debug client 21 or previously recorded in the auxiliary memory device 102. The address information includes a port number of a port opened by the debug server 11.

Meanwhile, the connection request receiving unit 111 of the debug server 11 opens a receiving port for the connection request when the debug server 11 is activated by the target machine 10 and waits for receipt of the connection request in step S201. When the connection request is received from the debug client 21 via the receiving port, the connection request receiving unit 111 takes out the program ID from the connection request in step S202.

Then, the debug object searching unit 112 searches plural processes activated in the target machine 10 for a process, with which a value matching the program ID is acquired, in step S203. In searching the process, the matching value may be stored in an area of a memory space to which “writing” is not performed. The process activated by the target machine 10 and the address of the memory space may be known by querying the OS.

If the process is not successfully searched (found) in NO of step S204, the connection request receiving unit 111 returns a response indicative of non-permission (refusal) of the connection of the debug server 11 to the debug client 21 in step S205. If the process is not successfully searched (found), the debug object searching unit 112 may repeat the step S203 to search for the process after passage of a predetermined time. The step S203 may be repeated until the process is successfully searched (found) or a number of times repeating the search may be limited to a predetermined number.

On the other hand, if the process is successfully searched (hereinafter, the process is referred to as “target process”) in YES of S204, the connecting unit 113 forms a logical communication path to the debug client 21. The target process is debugged in the remote debugging through the logical communication path in step S206. The connection unit 113 returns a response indicative of permission for the connection via the communication path to the debug client 21. The logical communication path may be formed by providing a new port corresponding to the debug client 21. In this case, the connection unit 113 may record matching information between the port number of the newly provided port (port number) and the process ID of the target process in the memory device 103. With this, a connection between the target process of the process ID and the debug client 21 may be constructed.

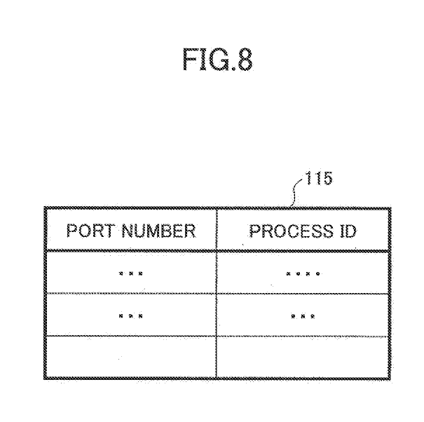

FIG. 8 illustrates example matching information between the debug client and the process to be debugged. As illustrated in FIG. 8, the matching information 115 indicates a matching between the port number and the process ID.

If the response from the debug server 11 is received in step S103, the debug client 21 branches the flow in step S104 depending on the content of the response. Said differently, if the connection is not permitted in NO of step S104, the debug client 21 performs an abnormal end by itself in step S105. Therefore, in this case the remote debugging is not carried out. If the connection is permitted in YES of step S104, the debug command requesting unit 213 communicates with the debug server 11 for the remote debugging in step S106. The communication is done via the communication path formed in the step S206. For example, the debug command requesting unit 213 transmits the debug command depending on the instruction input from the user to the debug server 11.

The debug command is received via the port of the debug server 11 opened in step S206. The debug command responding unit 114 determines a process ID matching the port number of the port receiving the debug command based on the matching information 115. The debug command responding unit 114 executes the debug command for the target process of the process ID in step S207. For example, values in the register, memory usage, setup and release of break points, overwriting of the register or the like are carried out. The debug command may have a mechanism similar to that of a known debugger. Therefore, description of the debug command is omitted.

Hereinafter, in response to inputs by the user, the steps S106 and S207 are repeatedly carried out to perform the remote debugging.

A measure of matching the debug client 21 with the process to be debugged is not limited only to the matching between the port number and the process ID. Said differently, information for identifying the debug client 21 is not limited to the port number. For example, the connection unit 113 may allocate unique session IDs respectively to the debug clients 21 and may record the matching information between the session IDs and the process IDs in the memory device 103. In this case, the response to the connection request includes the session ID. The debug command requesting unit 213 of the debug client 21 transmits the session ID together with the debug command to the debug server 11. The debug command responding unit 114 of the debug server 11 determines the process based on the session ID and the matching information. The program ID may be used as the session ID. In this case, ports may not be opened respectively for the debug clients 21. The port for receiving connection requests may also be used in common for receiving the debug commands from the debug clients 21. This is because the logical communication paths with the debug clients 21 are secured by the session IDs. Said differently, the debug server 11 can recognize the debug clients 21 transmitting the debug commands using the session IDs.

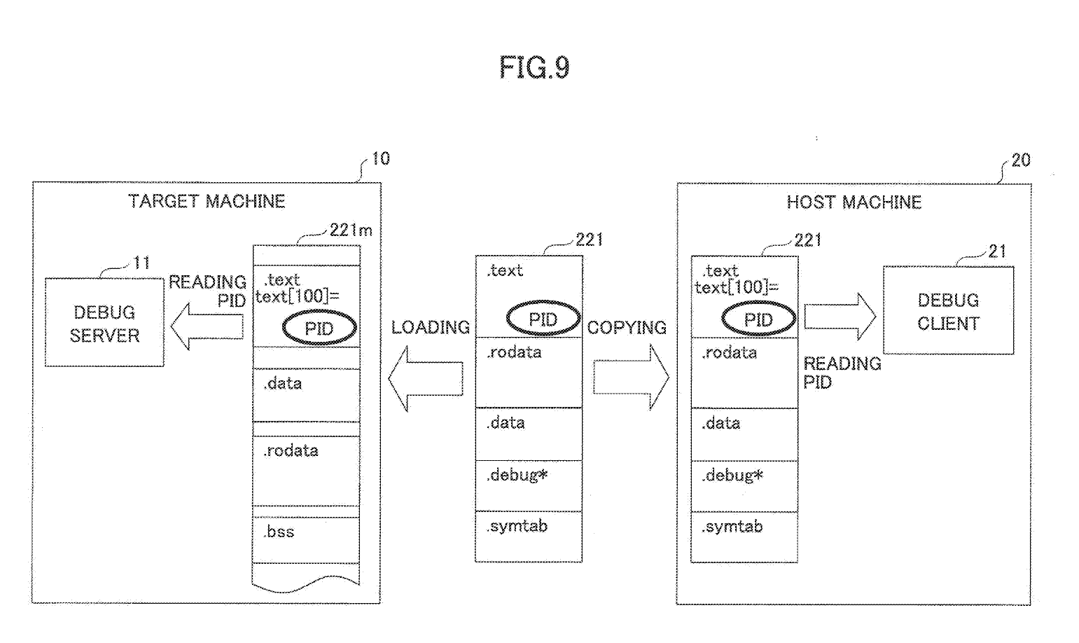

Next, a detailed description of the program ID is given. FIG. 9 illustrates a first example of a program ID.

With the first example, a program ID is recorded at a specific position of an executable file 221. For example, the program ID is generated by a compiler when a source code is compiled and recorded (embedded) at the specific position of the executable file 221. The specific position may be a section (e.g., read-only section) which is only referred to at a time of executing the program, said differently, a part of a section (i.e., non-writing section) to which “writing” is not performed. Here, the section is a unit of arrangement at a time of arranging the data (e.g., program) inside the executable file 221 into the memory. The section may include “.text”, “.data”, “.bss”, “.rodata”, and so on.

The section “.text” is provided to store a machine language included in the program. Therefore, “writing” is not performed for the section “.text”. The section “.data” is provided to store a variable having an initial value included in the program. Therefore, “writing” is performed for the section “.data”. The section “.bss” is provided to store a variable without having an initial value included in the program. Therefore, “writing” is performed for the section “.bss”. The section “.rodata” is provided to store a constant included in the program. Therefore, “writing” is not performed for the section “.rodata”.

Referring to FIG. 9, the program ID is recorded at the hundredth byte (.text[100]) from the head of “.text”. In FIG. 9 and the succeeding figures, “PID” stands for a program ID.

In this case, the program ID acquiring unit 211 of the debug client 21 acquires a program ID having a predetermined byte number, which is counted from the hundredth byte from the head of the execution code section of the executable file 221.

The debug object searching unit 112 of the debug server 11 acquires a program ID having a predetermined byte number from the hundredth byte which is counted from the head of the execution code section in a memory space (memory image) 221m of the process generated by loading the executable file 221. Said differently, the debug object searching unit 112 searches for a process including a part of data in the memory space of the process matching the received program ID.

Information indicative of positions of sections forming the executable file 221 is recorded in the executable file 221. However, the information is not included in the memory image after loading the sections. In the memory image, delimiters of the sections are not always clarified. Therefore, the debug object searching unit 112 may not specify starting positions of the sections. A process ID acquiring unit may read address information in which the section storing the process ID is loaded from the executable file 221 at a time of acquiring the process ID. The connection request transmitting unit 212 transmits a connection request by designating the address information and the process ID. The debug object searching unit 112 of the debug server 11 specifies the position of the program ID in the memory space 221m based on the designated address information.

The positions of the sections in the memory space 221m may be determined when the debug object searching unit 112 refers to the executable file 221 stored in the target machine 10.

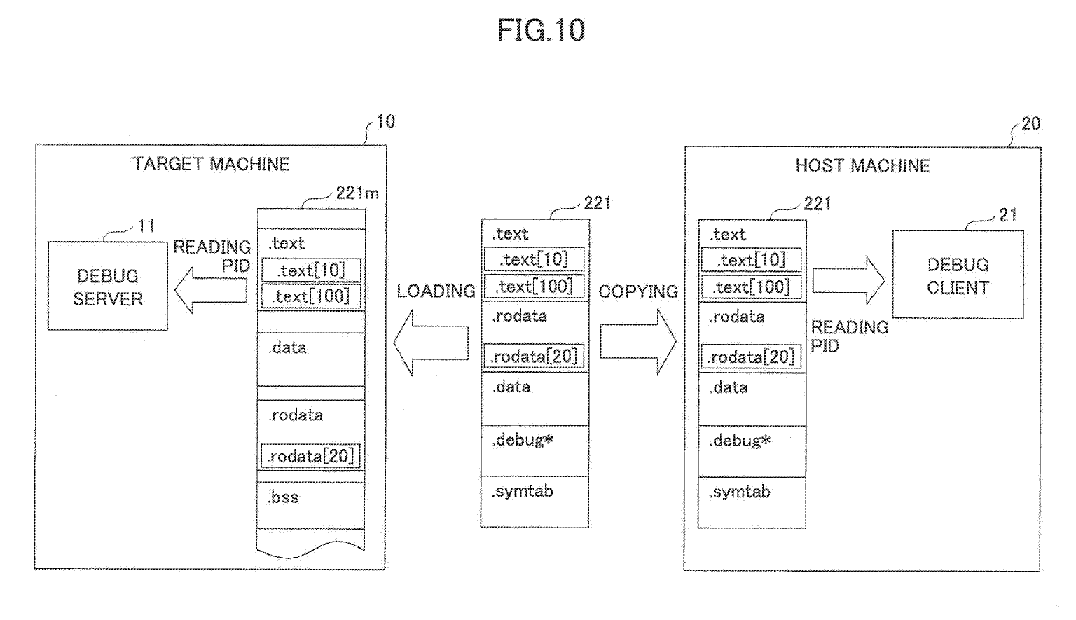

FIG. 10 illustrates a second example of the program ID. The program ID of the second example is generated using values obtained by connecting predetermined plural parts inside the section to which “writing” is not performed.

Referring to FIG. 10, the program ID is generated by connecting data of a predetermined byte number from the tenth byte (“.text[10]”) counted from the head of “.text”, data of a predetermined byte number from the hundredth byte (“.text[100]”) counted from the head of “.text”, and data of a predetermined byte number from the twentieth byte(“.rodata [20]”).

In this case, the program ID acquiring unit 211 of the debug client 21 generates the program ID by connecting data acquired from corresponding portions of the executable file 221.

Further, the debug object searching unit 112 of the debug server 11 generates a program ID obtained by connecting data acquired from the corresponding portions of the memory space 221m of the process generated by loading the executable file 221. Said differently, the debug object searching unit 112 searches for a process including the value that is obtained by connecting data of predetermined portions in the memory space of the process and matches the received program ID.

With the second example, the program ID may not be previously recorded in the executable file 221. By connecting plural portions of the program, it is possible to enhance uniqueness of the program relative to the program ID.

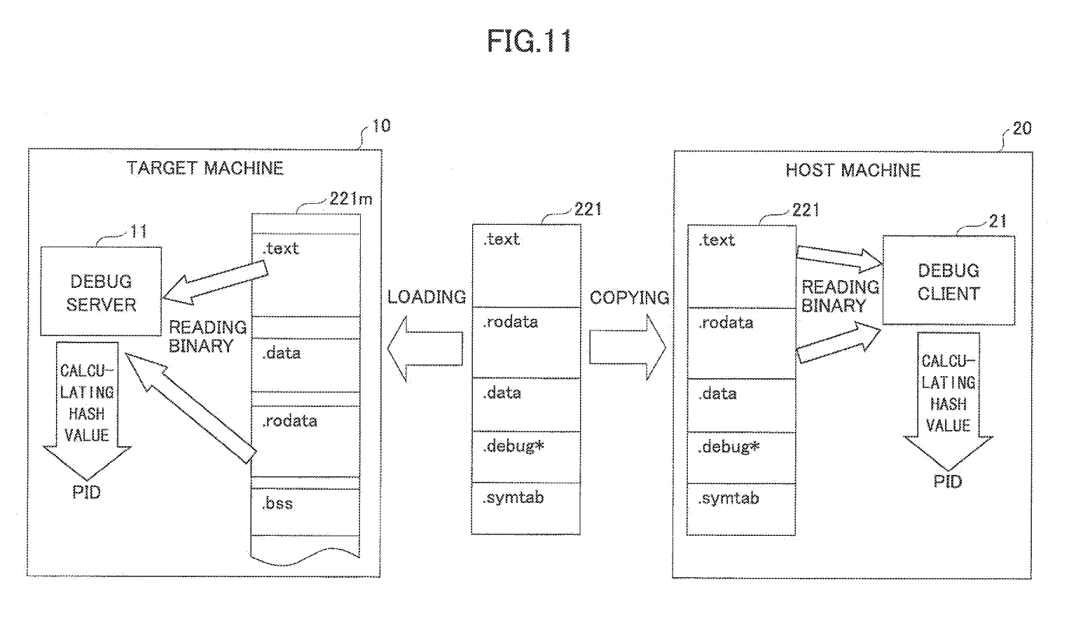

FIG. 11 illustrates a third example of the program ID. The third example of the program ID is generated by carrying out a predetermined conversion to a part or all of sections to which “writing” is not performed.

In the example, a hash value of binary data of “.text” and “.rodata” is calculated as the program ID. A hash function used for this is not limited to a predetermined function. For example, MD5 may be used. Further, a result of encrypting with an encrypting algorithm such as a Data Encryption Standard (DES) may be used as the program ID.

In this case, the program ID acquiring unit 211 of the debug client 21 carries out a predetermined conversion process to a predetermined part or all of the sections to which “writing” is not performed, and a result of the conversion is used as the program ID.

The debug object searching unit 112 of the debug server 11 performs the predetermined conversion to the predetermined part or all of the sections, which are not written to the memory space 221m of the process generated by loading the executable file 221. The result of the conversion is used as the program ID. Said differently, the debug object searching unit 112 searches for a process matching the program ID obtained by the conversion and received.

With the third example, the program ID can be generated based on a wider area of the program than the area of the program in the second example. Therefore, it is possible to further enhance the uniqueness of the program ID for the programs.

As described in the Embodiment, the debug server 11 can match the debug client 21 (debug information 22) with the process to be debugged based on the program ID. Therefore, even if plural processes related to different programs are activated in the target machine 10, it is possible to properly establish relationships for the debugging. As a result, the remote debugging under a multiprocess environment can be properly realized. For example, if the number of processes to be debugged increases, it is possible to provide comfortable debugging to a developer.

With the Embodiment, the Operating System (OS) of the target machine 10 may not have a special function in matching the processes to be debugged and the debug client. Therefore, processes in a virtual machine and processes to be loaded at a time of booting a system may be properly debugged.

The process for acquiring the program ID can be realized while reducing memory usage and shortening a CPU running time. Therefore, the debugging support program, debugging support device, and debugging support method of the Embodiment can be easily installed in a target machine whose hardware resources are limited.

With the Embodiment, the remote debugging for the plural processes are properly realized.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable, non-transitory medium storing a debugging support program that causes a target computer to perform a procedure, the procedure comprising:
receiving a connection request for remotely debugging a process, of which an identifier is designated for the remote debugging, using a host computer;
searching a plurality of processes activated in the target computer for the process having the designated identifier; and
connecting the target computer to the host computer to enable remotely debugging the searched process having the designated identifier.

2. The computer-readable, non-transitory medium according to claim 1,
wherein the searching determines for the process having the designated identifier whether at least a part of data, included in a non-writing section, into which writing is not performed, of a memory space used for the plurality of activated processes matches the designated identifier.

3. The computer-readable, non-transitory medium according to claim 1,
wherein the searching determines for the process having the designated identifier whether a value obtained by connecting a plurality of data, included in non-writing sections, into which writing is not performed, of a memory space used for the plurality of activated processes matches the designated identifier.

4. The computer-readable, non-transitory medium according to claim 1,
wherein the searching determines for the process having the designated identifier whether a result of providing a predetermined conversion to data, included in a non-writing section, into which writing is not performed, of a memory space used for the plurality of activated processes matches the designated identifier.

5. A debugging support device comprising:
a receiving unit configured to receive a connection request for remotely debugging a process, of which an identifier is designated for the remote debugging, using a host computer;
a searching unit configured to search a plurality of processes activated for the process having the designated identifier; and
a connecting unit configured to connect with the host computer to enable remotely debugging the searched process having the designated identifier.

6. The debugging support device according to claim 5,
wherein the searching unit determines for the process having the designated identifier whether at least a part of data, included in a non-writing section, into which writing is not performed, of a memory space used for the plurality of activated processes matches the designated identifier.

7. The debugging support device according to claim 5,
wherein the searching unit determines for the process having the designated identifier whether a value obtained by connecting a plurality of data, included in non-writing sections, into which writing is not performed, of a memory space used for the plurality of activated processes matches the designated identifier.

8. The debugging support device according to claim 5,
wherein the searching unit determines for the process having the designated identifier whether a result of providing a predetermined conversion to data, included in a non-writing section, into which writing is not performed, of a memory space used for the plurality of activated processes matches the designated identifier.

9. A debugging support method comprising:
receiving a connection request for remotely debugging a process, of which an identifier is designated for the remote debugging, using a host computer;
searching a plurality of processes activated in the target computer for the process having the designated identifier; and
connecting the target computer to the host computer to enable remotely debugging the searched process having the designated identifier.

10. The debugging support method according to claim 9,
wherein the searching determines for the process having the designated identifier whether at least a part of data, included in a non-writing section, into which writing is not performed, of a memory space used for the plurality of activated processes matches the designated identifier.

11. The debugging support method according to claim 9,
wherein the searching determines for the process having the designated identifier whether a value obtained by connecting a plurality of data, included in non-writing sections, into which writing is not performed, of a memory space used for the plurality of activated processes matches the designated identifier.

12. The debugging support method according to claim 9,
wherein the searching determines for the process having the designated identifier whether a result of providing a predetermined conversion to data, included in a non-writing section, into which writing is not performed, of a memory space used for the plurality of activated processes matches the designated identifier.
